(19) United States
(12) Patent Application Publication
(10) Pub. No.: US 2023/0165428 A1
(43) Pub. Date: Jun. 1, 2023

(54) DOMESTIC APPLIANCE

(71) Applicant: BSH Hausgeräte GmbH, Munich (DE)

(72) Inventors: Alexander Sing, Wittislingen (DE); Sami Bisgin, Dillingen (DE)

(21) Appl. No.: 17/912,876

(22) PCT Filed: Mar. 11, 2021
(86) PCT No.: PCT/EP2021/056178

§ 371 Date: Sep. 20, 2022

(30) Foreign Application Priority Data
Mar. 30, 2020 (DE) 10 2020 204 085.0

(51) Int. Cl. A47L 15/42; B32B 5/18; B32B 27/40; B32B 27/20

(52) U.S. Cl. CPC A47L 15/4209; B32B 5/18; B32B 27/40; B32B 27/20; B32B 2307/102; B32B 2266/0278; B32B 2307/72; B32B 2264/10; B32B 2509/00

(57) ABSTRACT

A household appliance includes a receiving region, and an insulating element attached to the receiving region and is set up to acoustically insulate the receiving region. The insulating element includes a foamed matrix material and particles embedded in the matrix material.

The present invention relates to a household appliance, in particular a water-guiding household appliance.

During the operation of a household dishwasher, there are many sound sources which may lead to a sound emission. This sound reaches the ear of a user and may be perceived negatively by the user. One possibility for reducing the sound is to reduce the sound emission at the sound source and thus to reduce the sound pressure entering the ear of the user. However, this is not always possible in a satisfactory manner, primarily in the case of sound events which are based on stochastic events or which may be influenced by the user. This may be the case, for example, with a spray jet in the interior of a washing container of the household dishwasher. A deflection of the spray jet is significantly influenced by the variable arrangement of items to be washed in the washing container. Thus it is not possible to prevent the spray jet from striking directly against the washing container. It is also not possible to specify at which point and at which angle the spray jet strikes against the washing container.

When designing the acoustic insulation, therefore, it has to be taken into account that an excitation of structure-borne sound may occur at any point of the washing container. Thus in the case of particularly quiet household dishwashers, provided it is possible technically and structurally, every point of the washing container has to be covered with an acoustically effective material in order to counteract this unavoidable excitation in an effective manner. These materials which are applied directly to the washing container primarily serve to dampen the structure-borne sound which is excited in the metal of the washing container or to dampen the structural vibrations thereof. In other words, the vibration amplitude of the surface, which is produced by the excitation in the interior of the washing container, is reduced by these acoustically effective materials. The energy of the structure-borne sound in this case is converted into heat in the acoustically effective material.

The publication EP 3 092 935 A1 discloses an arrangement for acoustically and thermally insulating a receiving region of a water-guiding household appliance. The arrangement comprises a first insulating element which is designed to insulate a receiving region thermally, and a second insulating element which is designed to insulate the receiving region acoustically, wherein the first insulating element is arranged between the receiving region and the second insulating element. In this case, the first insulating element is directly foamed onto the receiving region.

Against this background, it is an object of the present invention to provide an improved household appliance.

Accordingly, a household appliance, in particular a water-guiding household appliance, is proposed. The household appliance comprises a receiving region and an insulating element which is attached to the receiving region and is set up to acoustically insulate the receiving region, wherein the insulating element has a foamed matrix material and particles embedded in the foamed matrix material.

Since the insulating element has the foamed matrix material and the particles embedded therein, an increase in the loss factor may be achieved in comparison with an insulating element without such particles. By the provision of the particles, the mass distribution in the insulating element may be changed in comparison with an insulating element without such particles. As a result, the loss factor of the insulating element may be increased.

The household appliance may be a household dishwasher. The household appliance, however, may also be a household washing machine or any other household appliance, such as for example a refrigerator, a stove, an oven or the like. The receiving region is, in particular, cuboidal or cube-shaped and comprises a bottom, a ceiling arranged opposite the bottom, two side walls arranged opposite one another, a door pivotably attached to the receiving region and a rear wall arranged opposite the closed door. The receiving region may be, in particular, a washing container for receiving items to be washed.

The insulating element may be provided on the bottom, on the ceiling, on the side walls, on the rear wall and/or on the door. To this end, a plurality of insulating elements may be provided. The insulating element, however, may also be configured such that it fully encloses the receiving region with the exception of the door. Alternatively, the insulating element may be arranged, for example, only on the side walls, only on the rear wall and/or only on the ceiling of the receiving region. The insulating element is suitable, in particular, for converting structure-borne sound into heat. The acoustic insulating properties of the insulating element are achieved thereby. However, the insulating element also has thermal insulating properties or thermal insulation properties.

The foamed matrix material preferably comprises a plurality of cells, pores or cavities which are configured in the foamed matrix material. The pores are preferably filled with air. The particles are embedded between the pores in the foamed matrix material. In other words, the foamed matrix material encloses the particles. Hereinafter, a differentiation is made between the foamed matrix material which has the pores and the unfoamed matrix material which does not have any pores. The foamed matrix material may also be denoted as foam, in particular as polyurethane foam, or is a foam, in particular a polyurethane foam.

The unfoamed matrix material may be converted to the foamed matrix material, for example, by means of a propellant. The unfoamed matrix material which is not yet crosslinked and/or not yet cured may be, for example, a mixture of two basic components, for example of a polyol and an isocyanate. By mixing these two basic components, in combination with a propellant, the foamed matrix material may be produced by a chemical reaction of the basic components with one another. The foamed matrix material has no foam structure between two adjacent pores and thus in this region may be understood to be unfoamed matrix material.

According to one embodiment, the insulating element at 40° C. and at a frequency of 100 to 800 Hz has a loss factor of greater than 0.2, preferably of greater than 0.35, further preferably of greater than 0.5.

As a result, an effective anti-drumming of the receiving region or an acoustic damping of vibrations of the receiving region is achieved. In the present case, the “loss factor” is to be understood to mean, with different types of physical vibrations, the relationship between the imaginary part, which is subject to loss, and the loss-free real part of a complex variable. The loss factor may be adapted by means of the particles to the respective field of application, i.e. to a defined temperature and frequency range.

According to a further embodiment, the insulating element has a thermal conductivity of between 20 and 80 mW/(m*K), preferably of between 40 and 60 mW/(m*K), further preferably of between 50 and 80 mW/(m*K).

As a result, it is ensured that the insulating element has effective thermal insulating properties or insulation properties. In particular, the foamed matrix material has the aforementioned thermal conductivity. Preferably, the foamed matrix material has a lower thermal conductivity than the particles.

According to a further embodiment, the insulating element has a density of less than 300 kg/m³, preferably of less than 250 kg/m³, further preferably of less than 200 kg/m³.

The density of the insulating element, however, may be selected to be of any value. In particular, the foamed matrix material has the aforementioned density. The unfoamed matrix material has a greater density than the foamed matrix material.

According to a further embodiment, the particles have a greater density than the matrix material.

Preferably, the particles have both a greater density than the foamed matrix material and a greater density than the unfoamed matrix material. As a result, it is ensured that the particles are able to form mass points in the foamed matrix material. For example metals, stone or other inorganic materials are relevant for the particles. Organic materials such as plastic are also relevant for the particles if the density of the particles is greater than that of the matrix material.

According to a further embodiment, the particles have a density of between 500 and 8000 kg/m³, in particular of 2,200 kg/m³.

The particles, however, may also have a density of less than 500 kg/m³ or of more than 8000 kg/m³.

According to a further embodiment, the particles are graphite particles, in particular expanded graphite particles.

Expanded graphite, also called expandable graphite, is produced as graphite. Expanded graphite is flaky. In this case, a graphite flake consists of layers of carbon atoms arranged in a honeycombed manner. Inside the layers, the carbon atoms are very tightly connected together by covalent bonds. However, only weak bonding forces are present between the individual layers, so that molecules may be deposited between the graphite layers. By depositing acids, the graphite is converted into expanded graphite. As soon as the expanded graphite is heated, the graphite flakes expand to a multiple of the original volume thereof.

According to a further embodiment, the particles have intumescent properties.

This relates, in particular, to the case where the particles are expanded graphite particles. “Intumescence” in the present case is to be understood to mean an expansion or swelling, i.e. an increase in the volume, of a solid by the action of heat, without a chemical conversion. In the case of a fire, in which the matrix material decomposes, the particles form an insulating layer as a heat brake. As a result, no further measure is required for the fire protection of the insulating element used.

According to a further embodiment, the matrix material is a polyurethane.

The foamed matrix material, in particular, is a polyurethane foam or may be denoted as a polyurethane foam. However, the matrix material may also be any other material. In the case where the matrix material is a polyurethane, this may be produced for example by means of the basic components isocyanate and polyol, which may be mixed together, for example, by the addition of a propellant. The foamed matrix material is produced with the embedded particles by a chemical reaction of the basic components with one another.

According to a further embodiment, the matrix material has viscoelastic properties.

In particular, the foamed matrix material has viscoelastic properties. In the present case “viscoelasticity” is to be understood to mean a partially elastic, partially viscous material behavior. Viscoelastic substances thus combine the features of solids and liquids.

According to a further embodiment, the particles are arranged so as to be evenly distributed in the matrix material.

In particular, the particles are arranged so as to be evenly distributed in the foamed matrix material. For example, the particles may be added to the aforementioned liquid mixture of the basic components. Alternatively, the particles may also be added to one of the basic components before mixing the basic components. The particles may serve as nucleation sites for the pores provided in the foamed matrix material. Thus, for example, a fine-celled pore structure may be achieved.

According to a further embodiment, the insulating element is directly foamed onto the receiving region.

As a result, a reliable and permanent connection is achieved between the receiving region and the insulating element. Chemical additives may be mixed with the matrix material, which ensure a reliable and permanent connection with the receiving region. Alternatively or additionally, the receiving region may be roughened where the insulating element is provided. The insulating element, however, may also be adhesively bonded to the receiving region or fused thereon. The insulating element may also be simply positioned on the receiving region.

According to a further embodiment, the modulus of elasticity of the particles is greater than the modulus of elasticity of the matrix material.

In particular, the modulus of elasticity of the particles is greater than the modulus of elasticity of the foamed matrix material and greater than the modulus of elasticity of the unfoamed matrix material. As a result, it is ensured that the matrix material acts as a spring-damper element and the particles act merely as mass points.

According to a further embodiment, the particles have particle sizes ranging from 200 to 1500 μm, preferably smaller than 750 μm, further preferably smaller than 500 μm.

In particular, the particles have a particle size of 0 to 1000 μm. The particle size is substantially smaller than 500 μm. In other words, particles which are larger than 500 μm are permitted. However, preferably 60% of the particles should be smaller than 500 μm. Preferably 80% of the particles, in particular 90% of the particles, are smaller than 500 μm.

According to a further embodiment, particles which are different from one another are provided, said particles differing in the particle size thereof, in the shape thereof, in the material thereof and/or in the quantity thereof added to the matrix material.

As a result, it is possible to cover a wide range of differently optimized loss factor maxima with one and the same matrix material. This may be used in order to manufacture components for different applications on the finished household appliance on a production line.

Further possible implementations of the household appliance also comprise not explicitly mentioned combinations of features or embodiments, which are described above or below, relative to the exemplary embodiments. In this case, the person skilled in the art will also consider individual aspects as improvements or additions to the respective basic form of the household appliance.

Further advantageous embodiments and aspects of the household appliance form the subject of the subclaims and the exemplary embodiments of the household appliance described below. Moreover, the household appliance is described in more detail by way of preferred embodiments with reference to the accompanying figures.

In the figures

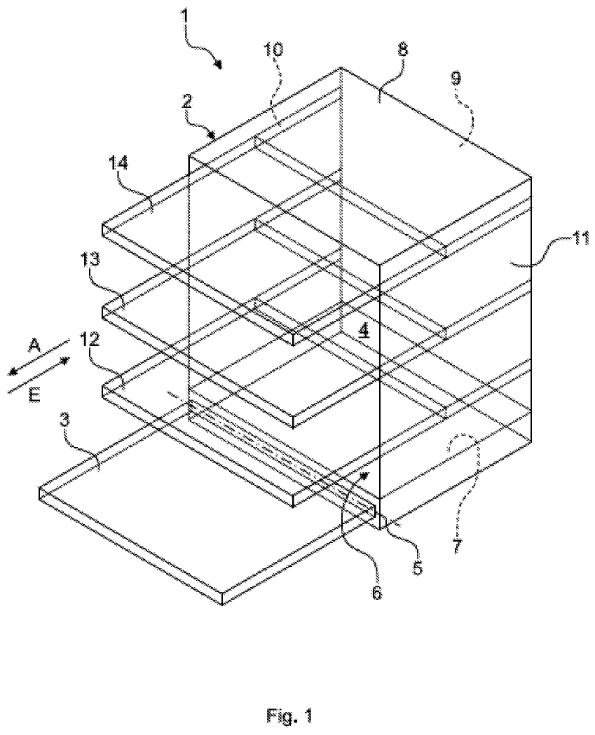

FIG. 1 shows a schematic perspective view of an embodiment of a household appliance;

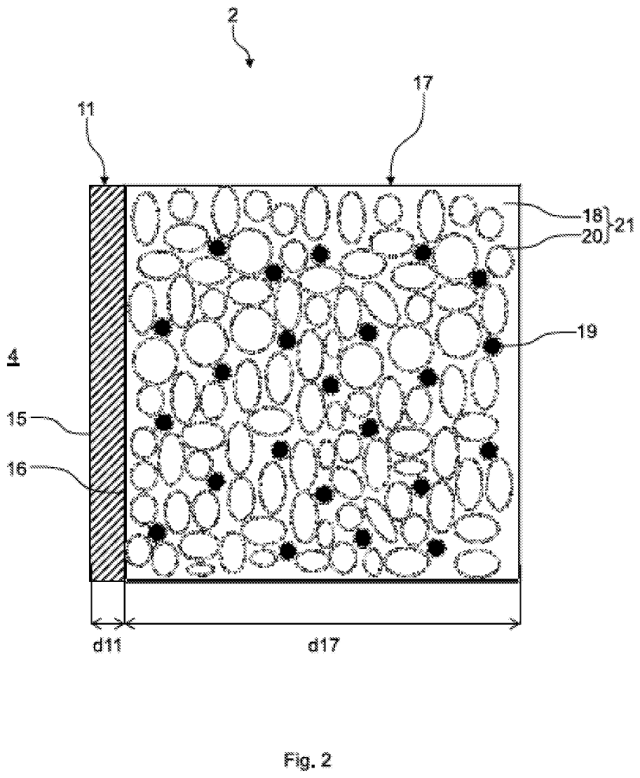

FIG. 2 shows a highly enlarged schematic sectional view of an embodiment of a receiving region of the household appliance according to FIG. 1;

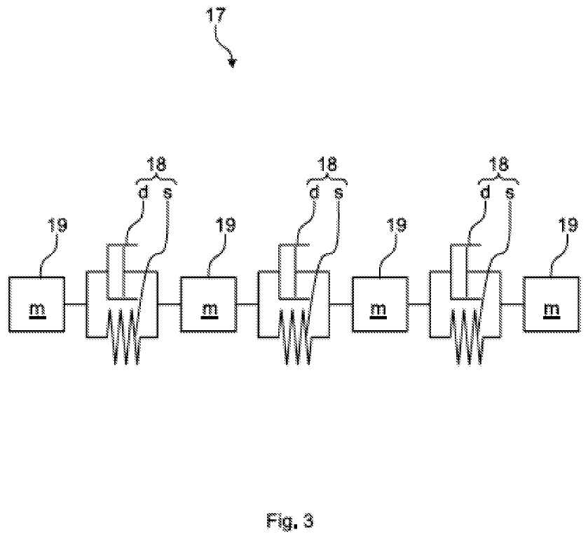

FIG. 3 shows a highly schematic view of an embodiment of an insulating element for the receiving region according to FIG. 2;

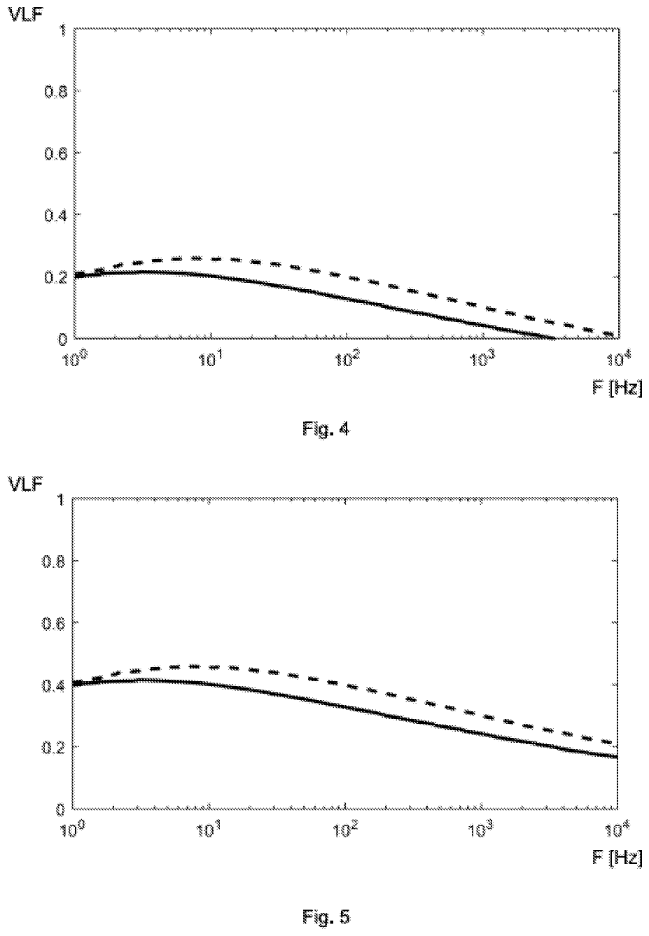

FIG. 4 shows a diagram in which the loss factor of the insulating element according to FIG. 3 is plotted against the frequency;

FIG. 5 shows a further diagram in which the loss factor of the insulating element according to FIG. 3 is plotted against the frequency; and

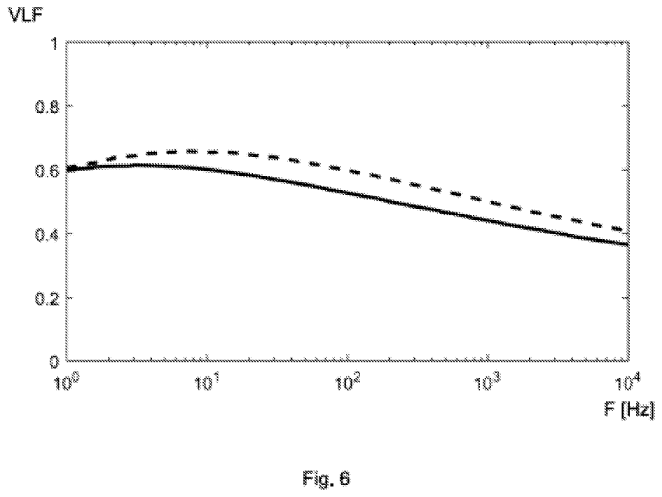

FIG. 6 shows a further diagram in which the loss factor of the insulating element according to FIG. 3 is plotted against the frequency.

In the figures, elements which are the same or functionally the same are provided with the same reference characters unless specified otherwise.

FIG. 1 shows a schematic perspective view of an embodiment of a household appliance 1. The household appliance 1 is, in particular, a water-guiding household appliance, such as for example a household dishwasher or a household washing machine. The household appliance 1, however, may also be a refrigerator, a stove, an oven or the like. Hereinafter, however, it is assumed that the household appliance 1 is a household dishwasher.

The household appliance 1 has a receiving region 2 which is able to be closed by a door 3, in particular in a water-tight manner. To this end, a sealing device may be provided between the door 3 and the receiving region 2. The receiving region 2 is preferably cuboidal. The receiving region 2 may be a washing container. The receiving region 2 may be arranged in a housing of the household appliance 1. The receiving region 2 and the door 3 may form a washing chamber 4 for washing items to be washed.

The door 3 is shown in FIG. 1 in the open position thereof. The door 3 may be closed or opened by pivoting about a pivot axis 5 provided at a lower end of the door 3. A loading opening 6 of the receiving region 2 may be closed or opened by means of the door 3. The receiving region 2 has a bottom 7, a ceiling 8 arranged opposite the bottom 7, a rear wall 9 arranged opposite the closed door 3 and two side walls 10, 11 arranged opposite one another. The bottom 7, the ceiling 8, the rear wall 9 and the side walls 10, 11 may be produced, for example, from a stainless steel sheet. The bottom 7 may be produced alternatively from a plastic material, for example.

The household appliance 1 also has at least one receptacle for items to be washed 12 to 14. Preferably, a plurality of receptacles for items to be washed 12 to 14, for example three thereof, may be provided, wherein the receptacle for items to be washed 12 may be a lower receptacle for items to be washed or a lower basket, the receptacle for items to be washed 13 may be an upper receptacle for items to be washed or an upper basket, and the receptacle for items to be washed 14 may be a cutlery drawer. As FIG. 1 also shows, the receptacles for items to be washed 12 to 14 are arranged one above the other in the receiving region 2. Each receptacle for items to be washed 12 to 14 is able to be displaced selectively into or out of the receiving region 2. In particular, each receptacle for items to be washed 12 to 14 is able to be pushed or moved in a push-in direction E (arrow) into the receiving region 2 and pulled or moved out of the receiving region 2 in a pull-out direction A (arrow) counter to the push-in direction E (arrow).

FIG. 2 shows a highly enlarged schematic sectional view of an embodiment of the receiving region 2. In particular, only a detail of the side wall 11 is shown in FIG. 2. The side wall 11 may be produced, as mentioned above, for example, from a stainless steel sheet. The side wall 11 comprises an inner face 15 facing the washing chamber 4 and an outer face 16 facing away from the washing chamber 4. The inner face 15 and the outer face 16 are positioned parallel to one another. The side wall 11 has a thickness d11. The thickness d11 may be, for example, 0.2 to 1 mm.

The household appliance 1 comprises an insulating element 17 which is attached to the receiving region 2 for the acoustic insulation of the receiving region 2, or acoustically insulating said receiving region. The insulating element 17 may also be denoted as an insulation element. The insulating element 17 may encase the receiving region 2. In other words, the insulating element 17 may be provided on the bottom 7, on the ceiling 8, on the rear wall 9, on the side walls 10, 11 and/or on the door 3. Alternatively, the insulating element 17 may also be provided, for example, only on the side walls 10, 11 or only on the side walls 10, 11 and on the rear wall 9. A plurality of insulating elements 17 may be provided. For example, in each case such an insulating element 17 may be assigned to each side wall 10, 11.

The insulating element 17 is provided on the outer face on the receiving region 2 facing away from the washing chamber 4. In particular, as FIG. 2 shows, the insulating element 17 is attached to the outer face 16 of the side wall 11. The insulating element 17 may be fused or adhesively bonded to the outer face 16, for example. The insulating element 17 may also be positioned only on the outer face 16. The insulating element 17 has a thickness d17 of preferably more than 2 mm, further preferably of more than 10 mm, further preferably of more than 15 mm. Thus the thickness d17 is preferably greater than the thickness d11 by a multiple thereof.

The insulating element 17 comprises a foamed matrix material 18 in which particles 19 are embedded. “Foamed” in the present case means that a plurality of cells or pores 20 are enclosed in the matrix material 18. The pores 20 may be filled, for example, with air. The pores 20 may have any geometry. For example, the pores 20 are spherical or ellipsoidal. The matrix material 18 and the pores 20 form together a polyurethane foam 21 (PUR foam). A polyurethane may be manufactured by a mixture consisting of a plurality of basic components, namely an isocyanate and a polyol. Moreover, the mixture may also contain a propellant. The isocyanate and the polyol are in each case liquids. If the propellant is present in the mixture of the isocyanate and the polyol, which leads to a degassing during the reaction of the isocyanate with the polyol, the matrix material 18 is foamed during the course of the chemical reaction, whereby the pores 20 are produced in the matrix material 18 and the polyurethane foam 21 is formed.

The pores 20 are preferably closed. In other words, the pores 20 are not connected together. The pores 20, however, may also be open or open-pored. In this case, the pores 20 are connected together. The matrix material 18 and thus the polyurethane foam 21 may be provided with very different material properties. The material properties substantially depend on the chemical ingredients of the basic components. Preferably, the polyurethane foam 21 has viscoelastic properties. “Viscoelasticity” in the present case is denoted as a partially elastic and partially viscous material behavior. Viscoelastic materials, therefore, combine all of the features of solids and liquids therein.

The polyurethane foam 21 or the insulating element 17 has a thermal conductivity of between 20 and 80 mW/(m*K), preferably of between 40 and 60 mW/(m*K), further preferably of between 50 and 60 mW/(m*K). The polyurethane foam 21 may have a density of less than 300 kg/m³, preferably of less than 250 kg/m³, further preferably of less than 200 kg/m³.

The insulating element 17 is preferably directly foamed onto the receiving region 2, in particular onto the side wall 11. To this end, chemical additives, which prevent the insulating element 17 from being released from the receiving region 2, may be admixed into the matrix material 18. Moreover, the outer face 16 of the side wall 11 may be alternatively or additionally pretreated, for example roughened, such that the connection between the insulating element 17 and the side wall 11 is not able to be released. Alternatively, the insulating element 17 may also be adhesively bonded onto the receiving region 2, fused thereon or even simply positioned thereon.

By the application of the insulating element 17 over the entire surface of the receiving region 2, an effective acoustic insulation of the receiving region 2 is ensured. An advantage of completely foaming around the receiving region 2 with the insulating element 17 is that gaps which are present may be sealed without spaces, whereby an improved acoustic insulation is further ensured.

The particles 19 are arranged so as to be evenly distributed in the matrix material 18. Moreover, the particles 19 may function as nucleation sites for the pores 20. The particles 19 are preferably mixed into the basic components of the matrix material 18 to be mixed. For example metal, stone or other inorganic materials are relevant as particles 19. Organic materials, such as for example plastic, are also relevant if the density and the modulus of elasticity of the particles 19 is greater than that of the matrix material 18.

Particularly preferably, the particles 19 are graphite particles, in particular expanded graphite particles. The use of expanded graphite particles has the advantage that in this case the particles 19 have intumescent properties. “Intumescence” in the present case is to be understood as an expansion or swelling, i.e. an increase in the volume of the particles 19 by the action of heat, without a chemical conversion thereof. In other words, the matrix material 18 may decompose by the action of heat on the insulating element 17, whilst the particles 19 configured as expanded graphite particles expand or swell and thus form a carbon foam functioning as a heat brake on or adjacent to the receiving region 2.

As mentioned above, the particles 19 have a greater density than the polyurethane foam 21 and than the matrix material 18. The particles 19 may have a density of between 500 and 8000 kg/m³, in particular of 2200 kg/m³. As mentioned above, the modulus of elasticity of the particles 19 is also greater than the modulus of elasticity of the matrix material 18. The particles 19 preferably have a particle size which is smaller than 500 μm. The particles 19 are present as powder and, due to the size thereof, are sufficiently small to be evenly distributed in the matrix material 18. The size of the particles 19 is substantially smaller than 500 μm. In other words, particles 19 which are larger than 500 μm are also permitted, but it is advantageous if 60% of the particles 19 are smaller than 500 μm. Preferably 80%, in particular 90%, of the particles 19 are smaller than 500 μm. By mixing the particles 19 into the matrix material 18, the pore structure of the polyurethane foam 21 changes. In other words, this means the size, the number and/or the geometry of the pores 20 in the insulating element 17.

For manufacturing the insulating element 17, the particles 19 are added to one or more of the liquid basic components of the matrix material 18 and evenly distributed in the mixture of the basic components. It is also possible to add the particles 19 to the already mixed basic components whilst they are still liquid. Moreover, different types of particles 19 may be combined from different substances. These particles 19 may also have differences in their size distribution and physical properties. If particles 19 which are similar or even different in terms of size, type and quantity are added, a large range of differently optimized insulating elements 17 may be manufactured with the same basic components. This may be used in order to manufacture insulating elements 17 for different applications on a production line.

The insulating element has at 40° C. and at a frequency of 100 to 800 Hz a loss factor of greater than 0.2, preferably of greater than 0.35, further preferably of greater than 0.5. The “loss factor” in the present case, with different types of physical vibrations, is to be understood as the relationship between the imaginary part, which is subject to loss, and the loss-free real part of a complex variable. The loss factor of the insulating element 17 may be influenced by adding the particles 19 to the matrix material 18. Advantageously, this relationship may be used if the loss factor is thereby increased over the entire frequency and temperature range or if an increase is also possible in the frequency and temperature range relevant for the individual case.

FIG. 3 shows a highly schematic view of the insulating element 17. The insulating element 17 comprises a plurality of mass points or masses m which are formed by the particles 19. Thus the particles 19 result in masses m in the polyurethane foam 21. The matrix material 18 with the pores 20, i.e. the polyurethane foam 21, forms spring stiffnesses s and damping members d. The insulating element 17 is thus shown as a spring-mass oscillator. The particles 19 significantly differ in the density thereof from the density of the filling gas of the pores 20 and ideally, but not necessarily, from the density of the matrix material 18. In other words, the density of the particles 19 is greater than the density of the matrix material 18 without the particles 19. This leads to a change in the structure of the mass distribution in comparison with a foam material without particles 19.

Moreover, as mentioned above, it is advantageous if the modulus of elasticity of the particles 19 is greater than the modulus of elasticity of the polyurethane foam 21 and also greater than the modulus of elasticity of the unfoamed matrix material 18. As a result, the matrix material 18 acts as a spring/damper element and the particles 19 act merely as masses m. The stiffness or the spring action of the particles 19 may be ignored in this case. This leads to an advantageous use of the properties of the damping members d in the insulating element 17 and thus to an increase in the loss factor.

If different resonance frequencies of the spring-mass oscillators are generated by the different masses m of the particles 19 and the variable spring stiffnesses s between the particles 19, a broad resonance peak may be generated. Within this resonance peak, the loss factor is increased by the efficient use of the damping members d. The viscous properties of the polyurethane foam 21 and the formation thereof as viscoelastic foam are advantageously used. Thus either the loss factor may be increased as a whole or improved in the relevant frequency and temperature range.

FIGS. 4 to 6 show in each case a diagram in which the loss factor VLF is plotted against the frequency F. In this case the solid line represents an insulating element, not shown, without particles 19 and the dashed line represents the above-described insulating element 17 with the particles 19. FIGS. 4 to 6 differ from one another by the variable output level of the loss factor VLF. According to FIG. 4, the output level of the loss factor VLF is 0.2. According to FIG. 5 the output level of the loss factor VLF is 0.4. According to FIG. 6 the output level of the loss factor VLF is 0.6. In other words, the increase in the loss factor VLF may start from any output level.

As may be clearly derived from FIGS. 4 to 6, the loss factor VLF in the insulating element 17 increases significantly relative to the insulating element without particles 19, not shown. Adding the particles 19 into the matrix material 18 changes the loss factor VLF. In particular, the loss factor VLF is increased.

An increase in the loss factor VLF by up to 30%, in particular by at least 20%, may be achieved. The loss factor VLF may be adapted and optimized to the application, i.e. to the actual frequency and temperature range, by the addition of the particles 19, for example by means of different materials, particle sizes or the like. The increased loss factor VLF leads to a reduced radiation of sound power. By controlling the quantity and type of the added particles 19, the loss factor VLF may be influenced over a wide range by one and the same matrix material 18.

Whilst the present invention has been described by way of exemplary embodiments, it may be modified in many different ways.

### REFERENCE CHARACTERS USED

1 Household appliance
2 Receiving region
3 Door
4 Washing chamber
5 Pivot axis
6 Loading opening
7 Bottom
8 Ceiling
9 Rear wall
10 Side wall
11 Side wall
12 Receptacle for items to be washed
13 Receptacle for items to be washed
14 Receptacle for items to be washed
15 Inner face
16 Outer face
17 Insulating element
18 Matrix material
19 Particle
20 Pore
21 Polyurethane foam
A Pull-out direction (arrow)
d Damping member
d11 Thickness
d17 Thickness
E Push-in direction (arrow)
F Frequency
m Mass
s Spring stiffness
VLF Loss factor

1-15. (canceled)

16. A household appliance, comprising:
a receiving region; and
an insulating element attached to the receiving region and is set up to acoustically insulate the receiving region, said insulating element including a foamed matrix material and particles embedded in the matrix material.

17. The household appliance of claim 16, constructed in a form of a water-guiding household appliance.

18. The household appliance of claim 16, wherein the insulating element at 40° C. and at a frequency of 100 to 800 Hz has a loss factor (VLF) of greater than 0.2, preferably of greater than 0.35, further preferably of greater than 0.5.

19. The household appliance of claim 16, wherein the insulating element has a thermal conductivity of between 20 and 80 mW/(m*K), preferably of between 40 and 60 mW/(m*K), further preferably of between 50 and 60 mW/(m*K).

20. The household appliance of claim 16, wherein the insulating element has a density of less than 300 kg/m³, preferably of less than 250 kg/m³, further preferably of less than 200 kg/m³.

21. The household appliance of claim 16, wherein the particles have a density which is greater than a density of the foamed matrix material.

22. The household appliance of claim 16, wherein the particles have a density of between 500 and 8000 kg/m³, in particular of 2200 kg/m³.

23. The household appliance of claim 16, wherein the particles have a density of 2200 kg/m³.

24. The household appliance of claim 16, wherein the particles are graphite particles.

25. The household appliance of claim 16, wherein the particles are expanded graphite particles.

26. The household appliance of claim 16, wherein the particles have intumescent properties.

27. The household appliance of claim 16, wherein the matrix material is a polyurethane.

28. The household appliance of claim 16, wherein the matrix material has viscoelastic properties.

29. The household appliance of claim 16, wherein the particles are arranged so as to be evenly distributed in the matrix material.

30. The household appliance of claim 16, wherein the insulating element is directly foamed onto the receiving region.

31. The household appliance of claim 16, wherein the particles have a modulus of elasticity which is greater than a modulus of elasticity of the matrix material.

32. The household appliance of claim 16, wherein the particles have a particle size ranging from 200 to 1500 μm.

33. The household appliance of claim 16, wherein the particles have a particle size smaller than 750 μm.

34. The household appliance of claim 16, wherein the particles have a particle size smaller than 500 μm.

35. The household appliance of claim 16, wherein the particles added to the matrix material and include particles which differ from one another in particle size, in shape, in material and/or in quantity thereof.
